(19) United States
(12) Patent Application Publication
(10) Pub. No.: US 2019/0114372 A1
(43) Pub. Date: Apr. 18, 2019

(54) SYSTEM AND METHOD FOR DETERMINING CONTACT NAMES THAT MAY IDENTIFY THE SAME PERSON

(71) Applicant: TIMOTHY JAMES SOUTHGATE, HALF MOON BAY, CA (US)

(72) Inventor: TIMOTHY JAMES SOUTHGATE, HALF MOON BAY, CA (US)

(21) Appl. No.: 15/787,685

(22) Filed: Oct. 18, 2017

(51) Int. Cl. G06F 17/30

(52) U.S. Cl. CPC G06F 17/30979

(57) ABSTRACT

A system and method for determining contacts names that may identify the same person. The system and method maintains one or more servers and one or more databases having contact records, wherein each contact record comprises one or more of a first name, middle name and a last name. The system and method selects a target contact record and determines a similarity score between the target contact record and one or more of the other contact records in the one or more databases. The system and method further displays one or more of the other contact records based, at least in part, on the similarity score.

### BACKGROUND OF THE INVENTION

Data processing systems are capable of processing information from a database. The types of information stored in a database is vast. However, in some instances, a database may comprise contact information for individual persons. Contact information for these persons may be stored as unique records for each individual. However, name duplication issues can arise when new records are added to the database for which the name in these records identifies a person that is associated with a record that already exists in the database, yet new duplicate records are created for the same person. Further, challenges exist when attempting to determine which name records are duplicates of the same person. As such, a system and method are needed for determining duplicate name records and further to avoid duplication issues when new name records are added to the database.

### SUMMARY OF THE INVENTION

Some embodiments of the invention provide for a method for determining contacts names that may identify the same person. The method maintains one or more servers and one or more databases having contact records, wherein each contact record comprises one or more of a first name, middle name and a last name. The method selects a target contact record and determines a similarity score between the target contact record and one or more of the other contact records in the one or more databases. The method further displays one or more of the other contact records based, at least in part, on the similarity score.

Some embodiments provide for a system comprising: one or more databases storing data objects of contact records having one or more or a first name, a middle name and a last name and a server system in communication with the one or more databases, wherein the server system has one or more processors configured to cause the following steps. The system determines a similarity score between the target contact record and one or more of the other contact records in the one or more databases. The method further displays one or more of the other contact records based, at least in part, on the similarity score.

Some embodiments provide a computer program product comprising computer-readable program code capable of being executed by one or more processors when retrieved from a non-transitory computer-readable medium, the program code including instructions configurable to cause the following steps. The computer program product maintains one or more servers and one or more databases having contact records, wherein each contact record comprises one or more of a first name, middle name and a last name. The computer program product selects a target contact record and determines a similarity score between the target contact record and one or more of the other contact records in the one or more databases. The computer program product further displays one or more of the other contact records based, at least in part, on the similarity score.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

In the following description, for the purposes of explanation, numerous specific details are set forth in order to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with other implementations as well. By the same token, however, no single feature or features of any described implementation should be considered essential to the invention, as other implementations of the invention may omit such features.

FIG. 1 illustrates a flow process for importing data records having a contact name associated with each data record.

FIG. 2 illustrates a flow process for searching for contact names in name database table.

FIG. 3 illustrates a flow process for comparing names in a database and determining whether they are the same person.

FIG. 4 illustrates a flow process for converting name database records into strings and comparing the strings.

FIG. 5 illustrates a flow process for merging contact records in a database.

FIG. 6 illustrates a flow process for identifying names that could represent the same person and therefore be merged in a contact records database.

FIG. 7 illustrates a flow process for determining a similarity score for an individual name, such as a first, middle or last name.

FIG. 8 illustrates a flow process for determining a total similarity score for a full name.

FIG. 9 illustrates an example database of name variations that may be used when comparing names.

FIG. 10 illustrates an example of similarity scores generated when comparing names.

FIG. 11 illustrates an example user interface for displaying a list of names that may be merged.

FIG. 12 illustrates an exemplary database comprising a Name table and an Information table.

FIG. 13 Illustrates a flow process for managing contact names that identify the same person.

FIG. 14 illustrates an exemplary information system architecture for storing information.

FIG. 15 illustrates an example device of the type that might be used to implement one or more of devices or servers.

### DETAILED DESCRIPTION OF THE INVENTION

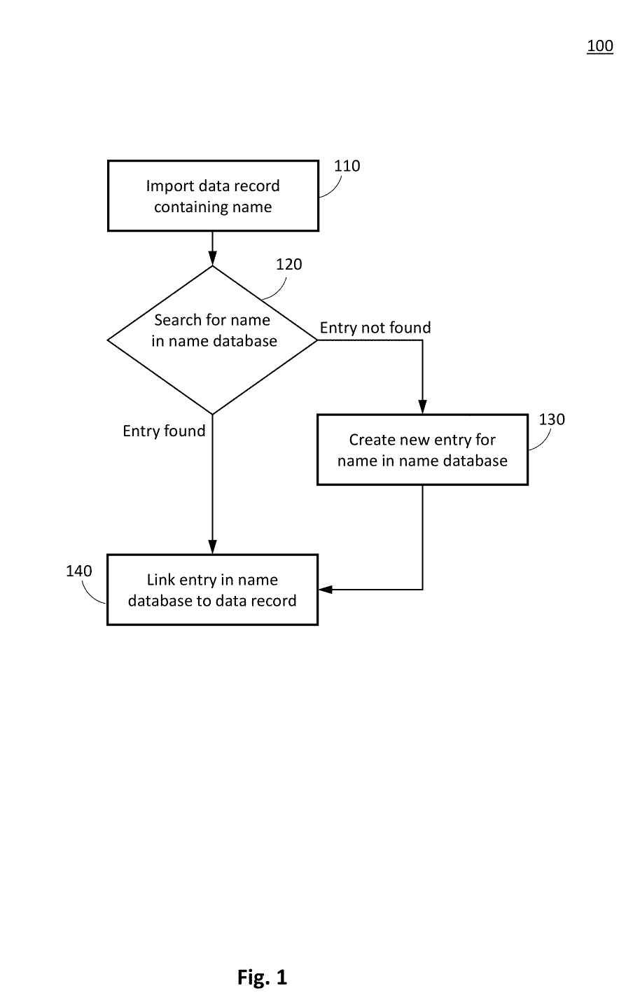

FIG. 1 illustrates a flow process 100 for importing data records having a contact name associated with each data record. In one embodiment, contact names are stored in a contacts database table within a relational database system, wherein each contact name is represented as an individual data record. Each contact record has one or more of a first name, middle name and a last name. Aside from a contacts table, the relational database system has an information table wherein each imported data record is stored. Each information data record at least comprises a contact name and one or more additional pieces of information. For example, a data record may include a contact name and information about a phone call, or another communication, made to the contact such as the date and time of the call, duration and to what phone number. In another embodiment, the information data records and contacts may be stored in worksheets within a single spreadsheet document. Additionally, the information data records may be stored in a separate spreadsheet file from the contact names.

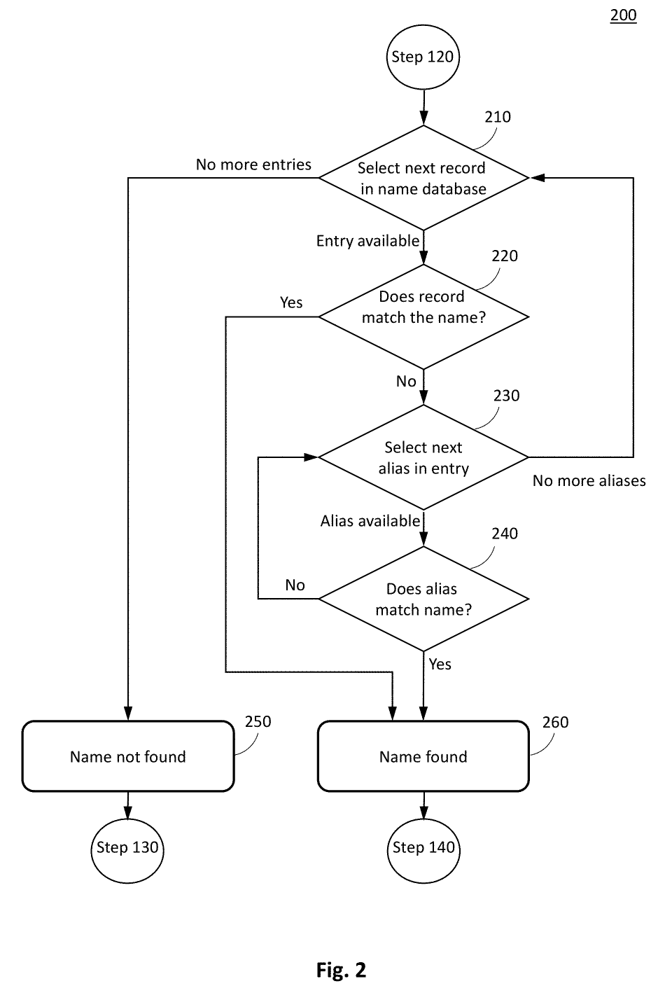

In an importing step 110 a data record, comprising information and a contact name, is imported into a database. Upon importing the data record a searching step 120 reads the contact name information from the data record and searches for the name in a name database table. FIG. 2 illustrates additional steps for name searching, which we be further described below. In a creation step 130, a new contact record is created in the name database table, if the name in the data record does not match an existing name in the name database table. Alternatively, a match is found if the contact name in the data record matches a record from the name database table. And a linking step 140 creates an association, or link, from the data record to record in the name database table. In other words, no additional name records are created in the name database table as previously illustrated in step 130.

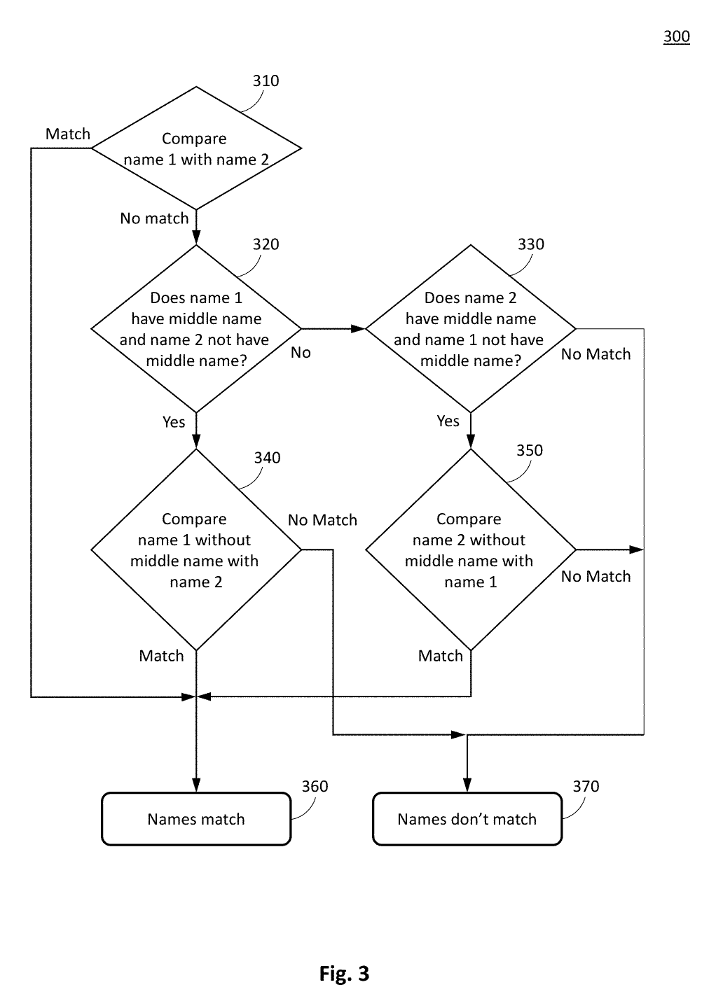

FIG. 2 illustrates a flow process 200 for searching for contact names in name database table. Prior to step 210 a contact name is received from the data record in Step 120 from FIG. 1. In a selecting step 210, a first record in the name database table is selected for comparison. In a comparing step 220, the name in the data record is compared to the first record in the name database table. If the names match, the flow process ends at step 260 and returns to step 140 in FIG. 1. In one embodiment, the names are considered a match if the spelling of the two names are identical. In another embodiment, as illustrated in FIG. 3, one or more identifying criteria may be used, in place of an exact match, in determining whether two names are considered one in the same person.

If the name in the data record does not match the first entry in the name database, the name database is queried to see if one or more name aliases are associated with first entry in the name database. In one embodiment, a contact record in the name database may have one or more aliases, wherein an alias may have a different spelling than the primary record. For example, a first name record may be Jonathan Smith. However, Johnny Smith or John Smith may be aliases of Jonathan Smith. It is possible for an alias to be drastically different than the primary name. For example, Janet K Dow may be an alias for Jane Doe even though the names may not appear to be the same person.

In one embodiment, name aliases may be defined in the database as being associated with a primary name. For example, the first record in the name database table may list the primary name as John Theodore Smith. However, the contact record may also include aliases for Johnny Smith, Jonathan T Smith and perhaps J “the Rocket” Smith. In one embodiment, the aliases may be stored in a single field in the contact record separated my commas, colons or semicolons to name a few. If the aliases field is empty the contact record does not have any aliases. In another embodiment, aliases may be stored as separate contact records in the name database, wherein a link or association is made between the alias and the primary contact record. In yet another embodiment, the database may include a separate table for aliases wherein links are established between contact records in the name table and alias records in the alias table. One skilled in the art of database development can appreciate that additional means for creating and linking names and alias are possible.

Returning to step 220, if a match isn't found between the name in the first data record and the first contact record in the name database table, selecting step 230 looks to see if an alias exists for the first contact record in the name table. If there are no aliases, the flow returns to step 210 and selects the next contact record. However, if an alias is found in step 230, comparing step 240 determines whether the name alias matches the name in the first contact record. If a match is found, the process ends at step 260 and the flow returns to step 140 in FIG. 1. If the alias is not a match against the name in the first contact record, the flow returns to step 230 and looks for additional name aliases. This process repeats until all aliases have been compared. If no match is found between the name in the first data record and all records in the name database, the flow returns to step 130 in FIG. 1.

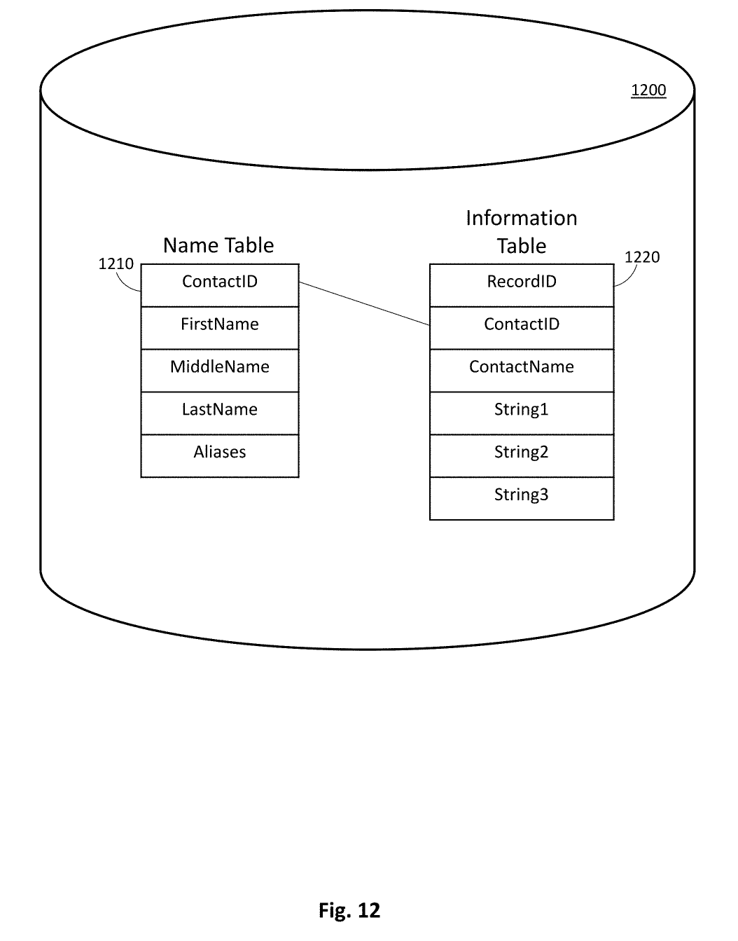

FIG. 12 illustrates an exemplary embodiment of a database 1200 comprising a name database table 1210 and an information database table 1220. The name table 1210 comprises FirstName, MiddleName, LastName and Aliases field names and a primary key called ContactID. ContactID is a unique identifier for each of contact records. The information table 1220 comprises ContactName, String1, String2 and String3 field names. The RecordID is the primary key for the table, wherein each RecordID is unique. A secondary key called ContactID points to a record in the name table sharing the same ContactID. Database 1200 is but one of numerous data models that may be used to represent name and other informational data, and is not to be construed as limiting in any way.

FIG. 3 illustrates a flow process 300 for comparing names in a database and determining whether they are the same person. The following process is used when a name comparison is requested in either step 220 or 240 of FIG. 2. A comparing step 310 compares the spelling of each name defined as name 1 and name 2. If an exact match is found the process ends at step 360 and an indication of the match is communicated to FIG. 2. If an exact match is not found, an analysis step 320 determines if name 1 has a middle name and name 2 does not have a middle name. If true, a comparing step 340 compares name 1, ignoring the middle name, against name 2 which did not have a middle name. If a match is not found, the process ends at step 370 and an indication of the failed match is communicated to FIG. 2. For example, is name 1 is John Andrew Smith and Name 2 is John Smith, step 340 ignores the Andrew and only compares John Smith from both names. If a match is found, the process ends at step 360 and an indication of the match is communicated to FIG. 2. If step 320 fails to produce a match, the flow passes to an analysis step 330. Analysis step 330 determines if name 2 has a middle name and name 1 does not have a middle name. If this is true, comparing step 350 compares name 2, ignoring the middle name, against name 1 which did not have a middle name. If a match is found, the process ends at step 360 and an indication of the match is communicated to FIG. 2. Alternatively, if a match is not found in step 350, the process ends at step 370 and an indication of the failed match is communicated to FIG. 2. As indicated in flow process 300, a full match may still be found if one of the names have a middle name and the other does not.

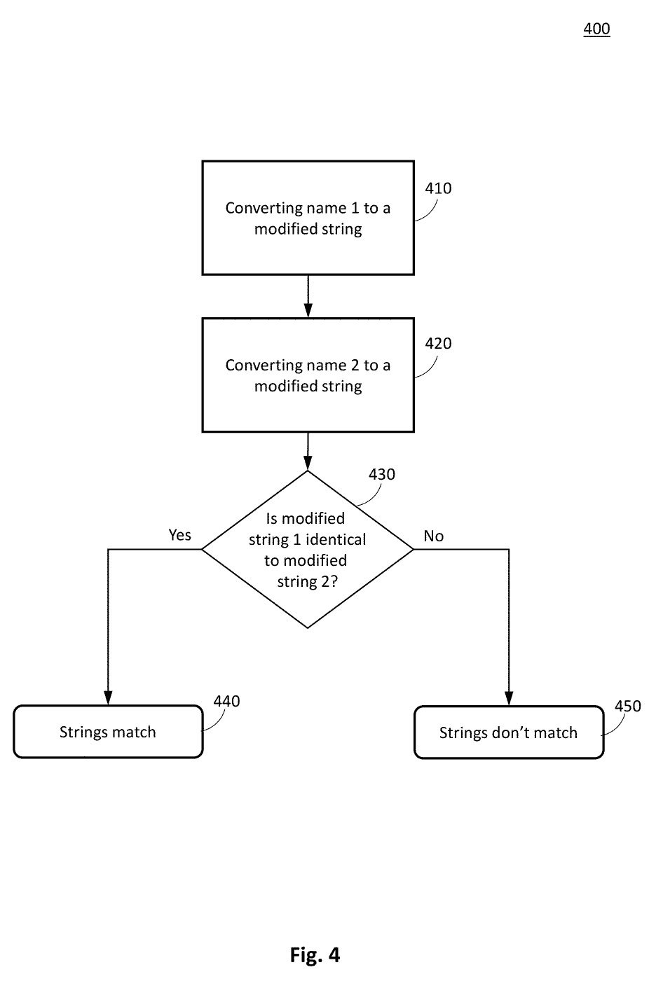

FIG. 4 illustrates a flow process for converting name database records into strings and comparing the strings. Characters and other attributes not important for comparing the names are removed. The following process may be used when any of comparison steps 310, 340 or 350 of FIG. 3 are performed. The process begins at a converting step 410 wherein any unimportant characters and attributes are removed from the first name (i.e., name 1). In one embodiment, unimportant characters may comprise apostrophes, accents, commas, numbers, and salutations to name a few. In another embodiment, all characters are converted to lower case. The resulting modified name 1 is placed into a string 1. A converting step 420 similarly modifies name 2 and places the resulting name into string 2. A comparing step 430 compares string 1 and string 2. If an exact match is found 440, the process returns FIG. 3 with information that a match was found. If a match is not found 450, the process returns to FIG. 3 with information that a match was not found.

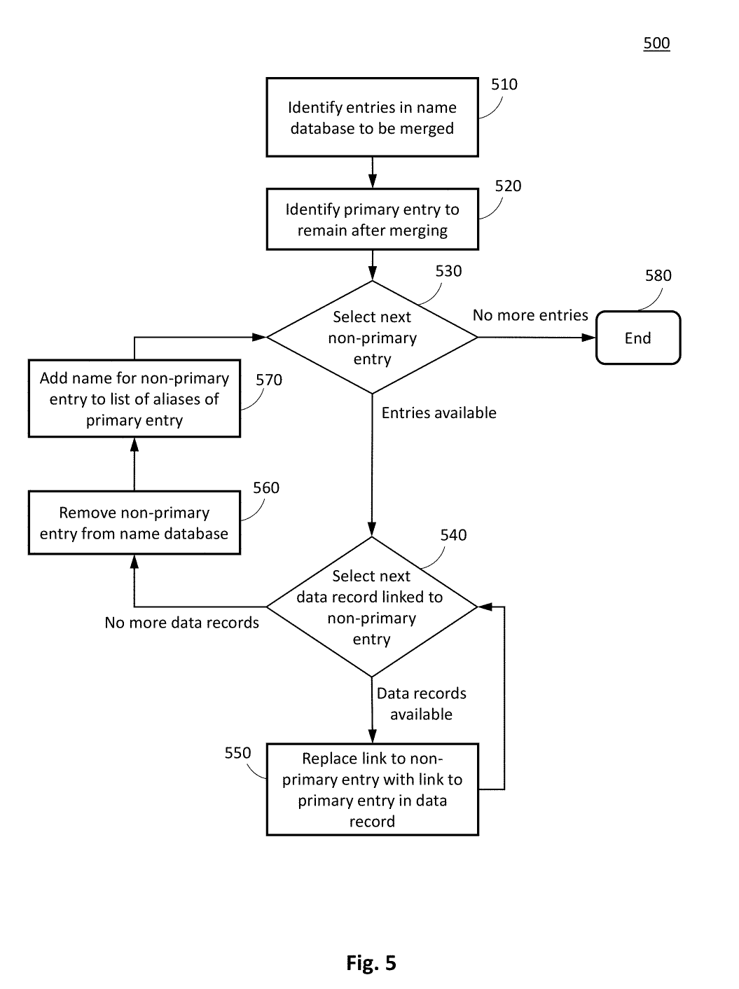

FIGS. 1-4 at least describe some processes for comparing contact names of imported data records against a name database to assist in determining if the name in a data record is the same as an existing name in the name database. FIGS. 5-11 illustrate one or more embodiments for comparing names in a name database and providing suggestions for merging name records that may be duplicates of the same person.

FIG. 5 illustrates a flow process 500 for merging contact records in a database. In an identifying step 510, a plurality of name records is identified as being the same person. In one embodiment, a list of names considered as the same person may be presented to a user on computing display or a printout. Once a plurality of names is identified for merging (hereinafter called a “merge group”), an identifying step 520 determines which name in the merge group will be the primary name to remain after merging. For example, a merge group may consist of three names which are identified as the same person. After merging, only the primary name remains in the database and all links to the other two names are replaced with a link to the primary name.

In one embodiment, the name database table may include additional contact information beyond name fields, such as: address, phone numbers, email addresses, websites, social media account information, etc. The primary name may be selected based on which name contact has the most additional contact information in the record. In another embodiment, step 520 may wait to receive user input on which name in the merge group will be the primary.

Once the primary name has been identified, a selecting step 530 selects the next, or the first, non-primary contact in the merge group. For example, a merge group may have three names. Name 1 is identified as the primary. Name 2 would be selected as the first non-primary record. Steps 540 and 550 would repeat for each of the remaining names in the merge group. Once all names in the merge group have been processed, steps 560 and 570 are performed and then the flow ends at step 580. A database may comprise additional data tables having other information besides contact information. For example, a database may also include a database table of communications made to contacts. Each record in the communications table may link to a name record in the name table. A first communication may be linked to John Alexander Smith (e.g., name 1) with a second communication being linked to John A. Smith (e.g., name 2). If name 2 is selected as a non-primary contact, step 540 selects the second communication record since it's linked to the non-primary contact. Replacing step 550 replaces the link between the second communication and name 2 and creates a link between the second communication and name 1, which is the primary name. Once the second communication's link from name 2 has been changed to name 1, the flow returns to step 540 looking for additional communication records linked to the non-primary contact called name 2. Step 540 and 550 repeats for each communication linked to name 2. Using a communication table is merely an example. Other database tables of information may be used. In another example, a database table may consist of patent applications, with each record linking to inventors in a contact name database table. A patent application 1 may link to an inventor 1 named John A. Smith. Inventor 1 may be selected as a non-primary name, with inventor 2 (“John Alexander Smith”) being selected as the primary name. The link from patent application 1 to inventor 1 may be replaced with a link to inventor 2 (the primary name).

Once all the data records linking to the non-primary name have been updated to link to the primary name, a step 560 adds the name of the non-primary contact as an alias in the primary contact name's data record. For example, John Alexander Smith was chosen as the primary name for the merge group. John A. Smith was selected as the first non-primary name. Step 560 adds John A. Smith as an entry into an aliases field in John Alexander Smith's contact record. This alias may be used when importing records as described in FIGS. 1-4. In an optional removal step 570 the non-primary contact record of John A. Smith may be deleted from the database since all other data records linking to John A. Smith have been updated to point to John Alexander Smith. In another embodiment, the orphaned contact record may be left in the contact name table.

Once step 570 has processed, the flow returns to step 530 to select additional non-primary contact names from the merge group. The flow continues until all the non-primary name in the merge group have been processed.

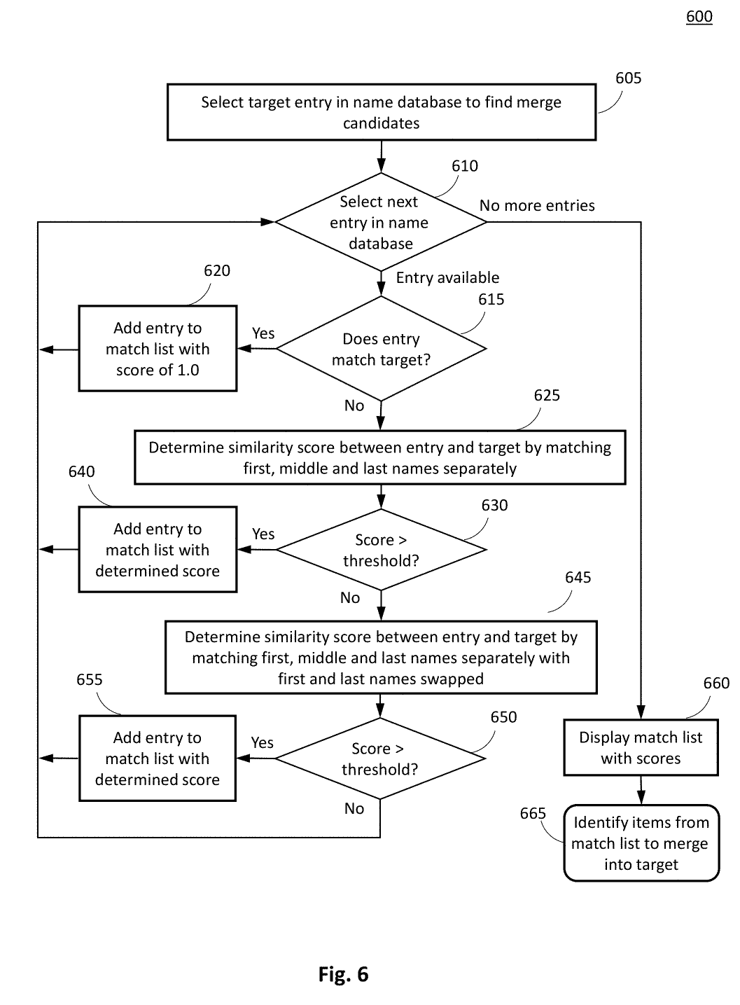

FIG. 6 illustrates a flow process 600 for identifying names that could represent the same person and therefore be merged in a contact records database. In one embodiment, a contact name database table exists in a relational database system. The contact name table may comprise fields for first name, middle name, middle initial, last name, salutation and suffix. As described in FIGS. 1-4, there may be one or more name alias fields. Further, each record may contain a primary key field having a unique value useful for joining to other database tables. One skilled in the art can appreciate that other data layouts of contact name information may be used, such as spreadsheet documents or individual worksheets within a spreadsheet document. Throughout this document, the term “entry” may considered as a single record in a database table.

In a selecting step 605, a target entry is selected from a name database to find other entries, or name database records, that may be merged into the target entry. As an example, the target entry is “Fred Anthony Jones”. A selecting step 610, selects an entry from the name database table. In one embodiment, the name is selected based on a unique value, such as the primary key, in the record. If each record has a sequential number starting at 1, the first selected entry may begin with 1. The next selected entry may have a primary key value of 2 and so on. Once a first entry is selected, a comparing step 615 determines whether the target entry and the first entry match. In one embodiment, the comparison is performed with the steps of FIG. 3. In another embodiment, a match may not be found unless the target entry and first entry match exactly. If the first entry is “Fred Anthony Jones”, a match is found and step 620 gives the first entry a maximum similarity score of 1.0 to indicate an exact match and the process begins again at step 610. In one embodiment, a match list is a database table having one record for each target entry in combination with each name entry in the database. The score may also be included in each record. In another embodiment, the maximum similarity score may be a value different from 1.0.

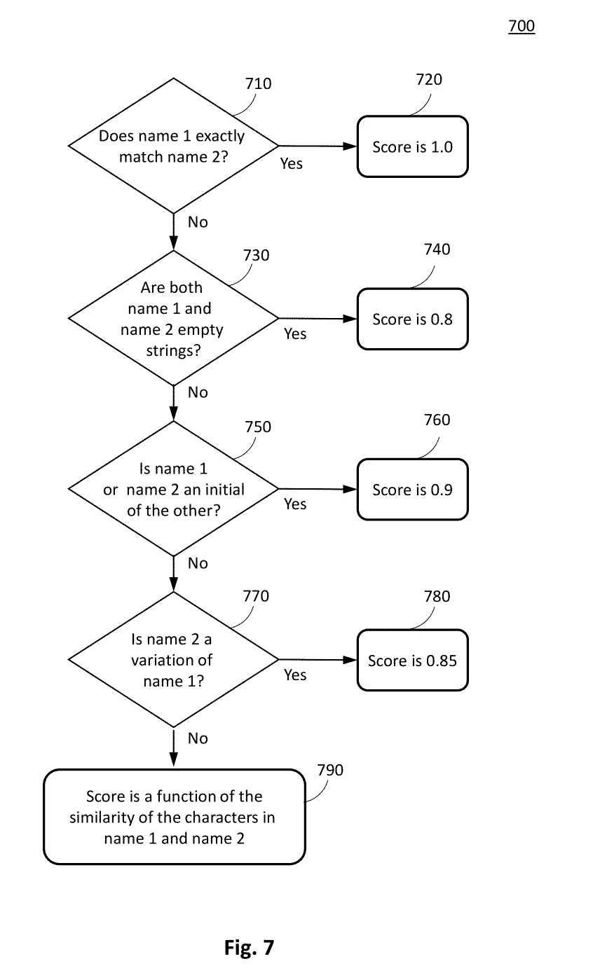

If step 615 does not find a match between the target entry and the first entry, a determining step 625 determines a similarity score between the two entries. A similarity score is found for each of first, middle and last names separately. FIG. 7, further illustrated below, describes processes for determining similarity scores between names. A comparing step 630 compares the similarity score, as calculated in Step 625, against a threshold score. In one embodiment, a similarity score is between 0.0 and 1.0 with match threshold being 0.7. However, one skilled in the art can appreciate that any scoring mechanism may be used. In one example, the target entry is “Fred Anthony Jones” and the first target is “Freddy J”, While the names are not an identical match, they are given a similarity score of, for example, 0.8. Since 0.8>0.7, the threshold is met and step 640 adds the first entry to the match list with a score of 0.8. and the loop restarts at step 610.

In contrast, if the first entry is “Jones Fred”, the similarity score may not meet the threshold. In this case, the process moves to step 645 where the first and last names of the first entry are swapped and then compared against the target entry to recalculate the similarity score. If the new similarity score is greater than the threshold, step 655 adds the first entry, and its score, to the match list and the loop starts over at step 610. If the first entry's similarity score, as calculated by step 645, is below the threshold, the entry is not added to the match list and the loop restarts at step 610.

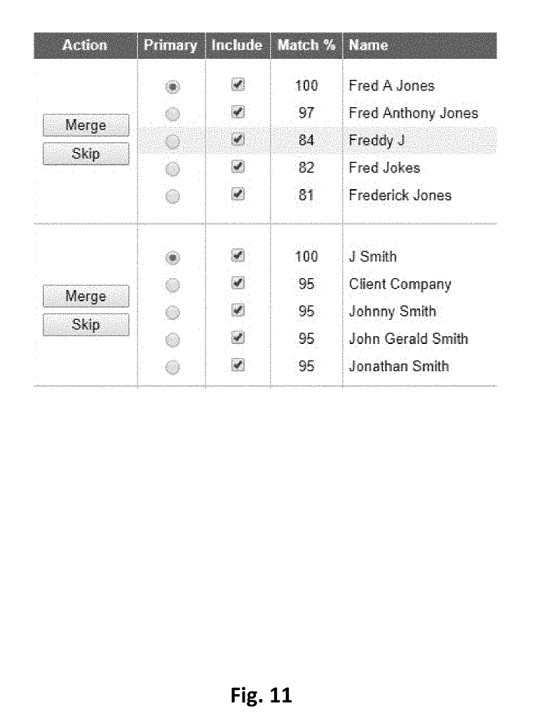

Once all entries have been compared against the target, the match list is complete. A displaying step 660 displays the match list on a computing display for analysis. Alternatively, the match list could be printed out via a printer. FIG. 11 illustrates an example of what a completed watch list may include. In an identifying step 665, entries from the match list are identified for merging into the target entry. In one embodiment, a person accessing a computing device may select these items from the device using a similar interface as shown in FIG. 11.

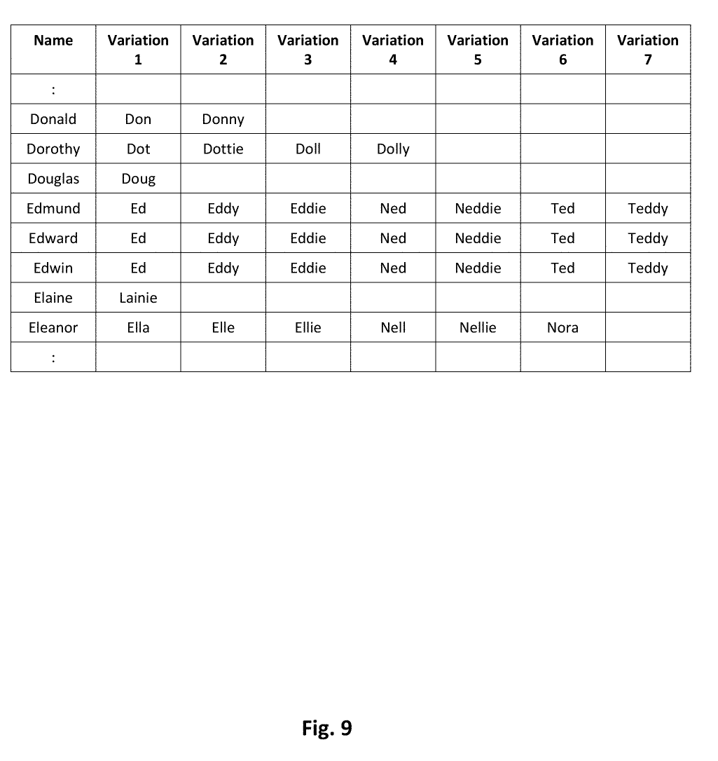

FIG. 7 illustrates a flow process for determining a similarity score for an individual name, such as a first, middle or last name. In a comparison step 710, a name 1 is compared to a name 2. For example, the name 1 may be a first name from the target entry described in FIG. 6 with name 2 being a first name from an entry being matched to the target. If they match exactly, step 720 gives the match a score of 1.0 and the process ends. If there is not an exact match, a comparison step 730 checks if name 1 and name 2 are empty strings. If so, step 740 gives them a score of 0.8. If the name are not empty strings, a comparison step 750 determines if name 1 or name 2 are initials of the other. For example, if name 1 is “Fred” and name 2 is “F”, the condition is met and Step 760 gives the pair a score of 0.9. If the condition is not met, a comparison step 770 determines whether name 2 is a variation of name 1. In one embodiment, a variation is a different spelling of the same base name. For example, Don and Donny may be variations of Donald. Thus, the condition is met if name 2 is “Don” and name 1 is “Donald”. In one embodiment, a database of name variations is accessed in step 770. FIG. 9 illustrates an example of a portion of a name variation database. Step 780 gives the pair a score of 0.85 if the condition of step 770 is met. If the condition of step 770 is not met, a step 790 gives the comparison a score that is a function of the similarity of the characters in name 1 and name 2. In one embodiment, similarities between name 1 and name 2 is determined by using the Jaro-Winkler function. However, one skilled in the art can appreciate that other functions may be used and different similarity scores could be generated and different thresholds utilized.

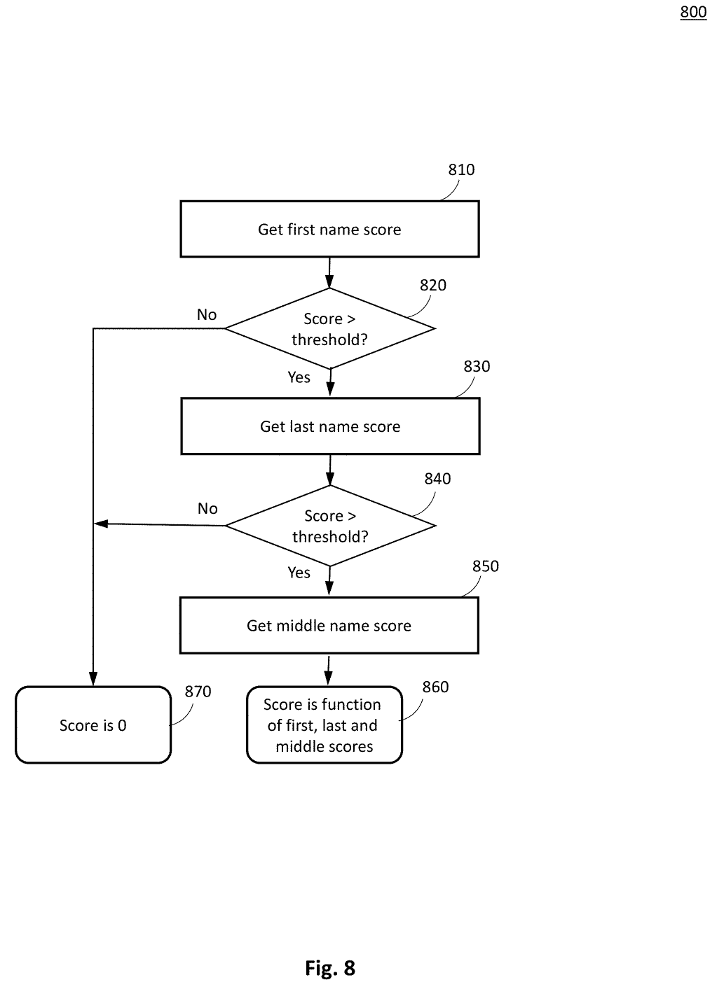

FIG. 8 illustrates a flow process for determining a total similarity score for a full name (i.e., first, middle and last names). The score for each individual name would have already been determined as described in FIG. 7. In a retrieval step 810, the score for the first name is retrieved. In a comparison step 820, the first name score is compared against a threshold value, for example 0.7. If the score is below the threshold, a scoring step 870 gives the total name a score of 0.0 and the flow ends. In other words, if any of the first, middle or last names are below the threshold, the overall score of the three names does not matter. If the first name's score meets the threshold, a retrieval step 830 retrieves the last name's score. In a comparison step 840, the last name score is compared against the threshold value. If the score is below the threshold, a scoring step 870 gives the total name a score of 0.0 and the flow ends. If the last name's score meets the threshold, a retrieval step 850 retrieves the middle name's score. A calculation step 860 calculates the final name score which is a function of the individual scores of the first, middle and last names. In one embodiment, the final name score is the average of the first, middle and last name scores. In another embodiment, the threshold for comparison at step 820 is different from the threshold for comparison at step 840.

FIG. 9 illustrates an example database of name variations that may be used when comparing first names. For example, Don and Donny are shown as variations of Donald. Further, Edmund has name variations of Ed, Eddy, Eddie, Ned, Neddie, Ted and Teddy. The table shown is merely an example. Other name variations or database schemas may be used to store such information.

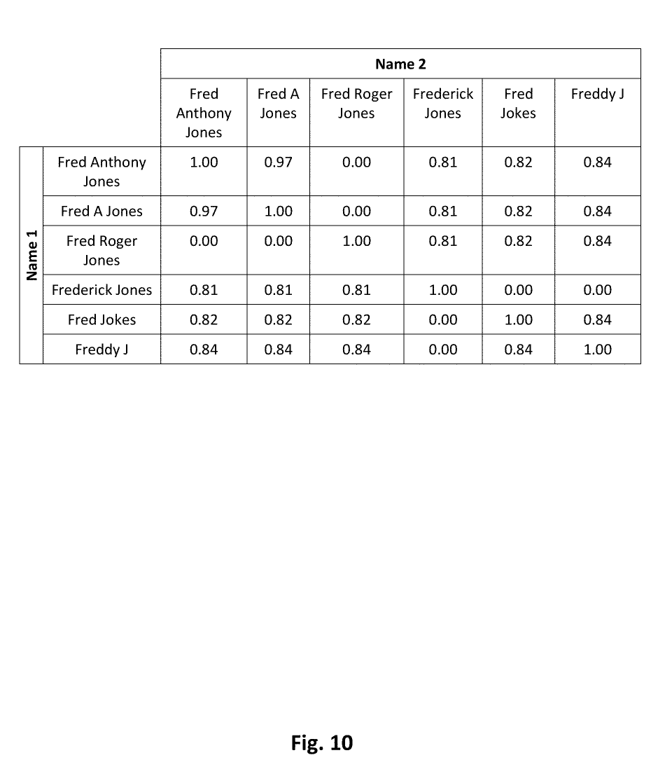

FIG. 10 illustrates an example database of full name comparisons and the similarity score between each name. For example, a comparison between Fred Anthony Jones and Fred A Jones has a similarity score of 0.95. Yet a comparison between Fred Anthony Jones and Fred Jokes has a score of 0.82. The comparisons shown merely illustrate one embodiment of how name similarities may be displayed or stored and should not be construed as limiting in any way.

FIG. 11 illustrates an example user interface for displaying a list of names that may be merged. Each suggested group of name variations are displayed in separate groups, with each group having two Action buttons, a Primary name indicator, an Include option, a Match % indicator and the name of each contact. In this example, five variations of Fred Jones are displayed, with Fred A Jones having a percentage score of 100. The four remaining variations have a descending score to illustrate a potential likelihood that they are the same person as Fred A Jones. A user is presented with the option to choose a primary contact via a radio button. A user also has the option to choose which contact variations will be included in a merge. For example, if only Fred A Jones and Fred Anthony Jones are included, clicking the Merge button results in these two contacts being merged while leaving the others as separate contacts. If all five variations are selected, clicking the Merge button results in all five contacts being merged into one contact (i.e., the name chosen as the primary.) Optionally, a user may click a Skip button which ignores the group of similar names. The Graphical User Interface illustrated in FIG. 11 is merely an example. Additional interfaces may be used to illustrate and interact with a user when deciding which contacts to merge.

FIG. 12 illustrates an exemplary database 1200 comprising a Name table 1210 and an Information table 1220. The Name table 1210 has a primary key field called ContactID with additional field called: FirstName, MiddleName, LastName and Aliases. The Information table 1220 has a primary key called RecordID and a secondary key called ContactID which may be used to connect records from the Information table 1220 with contacts in the Name table 1210. The Information table 1220 has additional fields called: ContactName, String1, String2 and String3. The ContactName field may be used to cross-reference the Name Table 1210 in determining whether the ContactName matches an existing contact record in the Name Table. The fields shown in each database table are merely example tables. Additional fields, tables or spellings may be used without deviating from the scope of the invention.

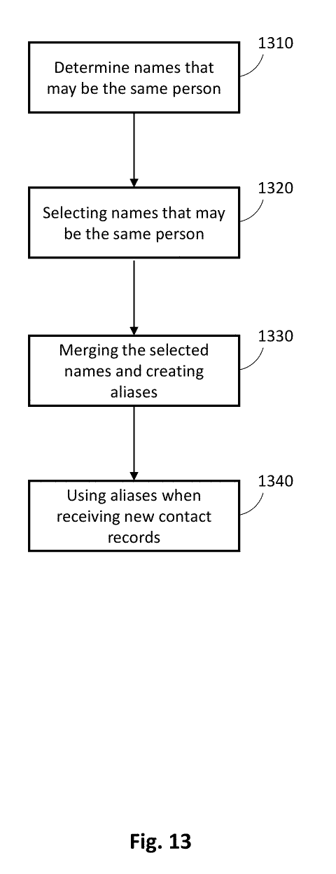

FIG. 13. Illustrates a flow process for managing contact names that identify the same person. In a determining step 1310, a processor, coupled to a database, scans through contact records, stored in one or more databases. Each contact record has one or more of a first name, middle name, or last name. During this step, each of the first, middle and last names of each contact record are compared against the first, middle and last names of other contact records.

In a selecting step 1320, the processor selects some of the contact records that may identify the same person. In one embodiment, a similarity score, as described above is determined between two different contact records. If the similarity score meets a threshold value, the processor may consider the two records as being the same person. Additionally, the processor may communicate the score to a display and await feedback of whether the two records are the same person. In a merging step 1330, the processor merges the two records into the one or more databases. In one embodiment, an association is established between the first contact record and the second contact record. Next, the name of the second contact record is added as an alias of the first contact record. In a utilization step 1340, the contact record aliases are used when new database records are received into the one or more databases. In one embodiment, when a new contact record is received, the processor considers the new contact record to be a match (e.g., identify the same person) to an existing contact record if the spelling of the name in the new contact record matches the spelling of the name in the existing record or the spelling of the names in any alias of the existing contact record. If this is the case, the new contact record is associated with the existing name.

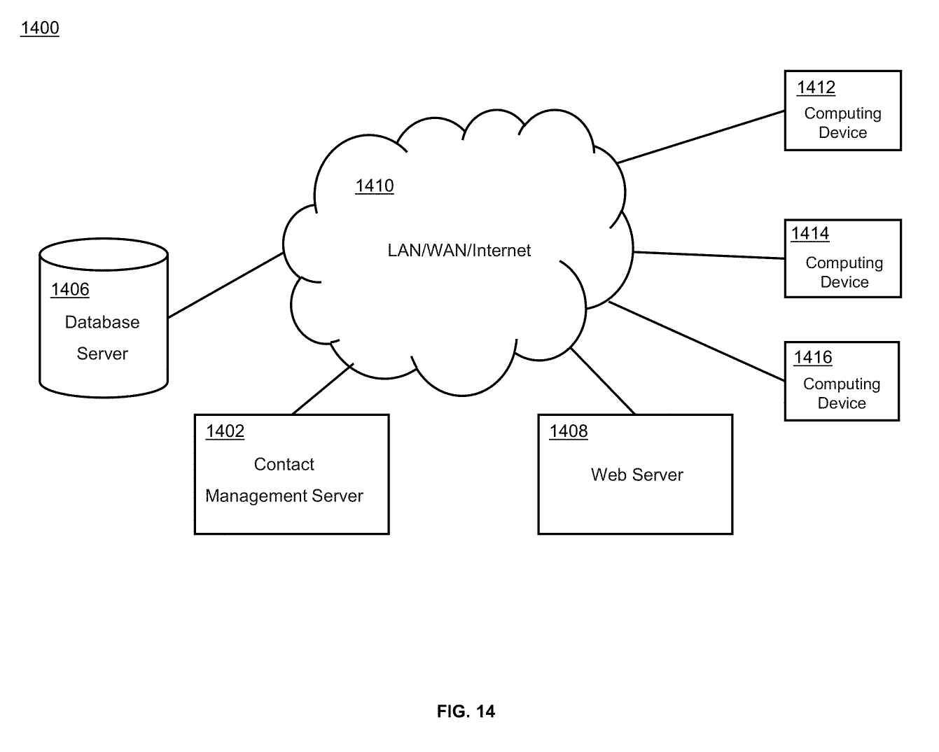

FIG. 14 illustrates an exemplary information system architecture 1400 for storing various types of information including contact records. Information system 1400 comprises a Contact Management Server 1402, a Database Server 1406, and a Web Server 1408. The Contact Management Server 1402, the Database Server 1406 and the Web Server 1408 are all communicatively coupled to each other through a network such as a LAN/WAN/Internet 1410. However, other communication means may be used without deviating from the scope of the invention. In one embodiment, any of the Servers 1402, 1406, and 1408 may comprise multiple physical servers. Additionally, one or more of the Servers 1402, 1406, and 1408 may be contained within the same physical server.

In one embodiment, the Contact Management Server 1402 receives information records, such as described in Information Table 1220 from FIG. 12, from the Web Server 1408. The Contact Management Server 1402 further receives a list of contact records from the Database Server 1406 and determines whether the name in the information records matches name in the contact list. The Contact Management Server 1402 provides instructions to the Database Server 1406 to either associate information records to existing contact records, or to create new contact records. In one embodiment, one or more of computing devices 1412, 1414 or 1416 may transmit information records to the Web Server 1408. Further, results of the processed information records may be transmitted back to one or more of the computing devices.

In another embodiment, information records may be sent directly to the Database Server 1406 and hence bypass the Contact Management Server 1402. The Database Server 1406 may then send the information records to the Contact Management Server 1402 for analysis as described in the above paragraph.

In another embodiment, the Contact Management Server 1402 analyzes a list of contact records and determines whether any of the records may be the same person. The Contact Management Server 1402 instructs the Database Server 1406 to merge any contact records found to be the same person. Additionally, the Contact Management Server 1402 may further receive a request, via Web Server 1408, from one or more of computing devices 1412-1416 to analyze contact records and provide a list of potential duplicates. The Contact Management Server 1402 may then transmit a list of potential duplicates and similarity scores back to a display on the computing device, via Web Server 1408. The Contact Management Server 1402 may further receive instructions back from the computing device, via Web Server 1408, on which records to merge.

In one embodiment, device 1412 is a display coupled to a computer, device 1414 is a smart phone, and device 1416 is a tablet. However, one skilled in the art can appreciate that different types of computing devices may be used to send and receive information from the Web Server 1408.

In one embodiment, the Web Server 1408 is communicatively coupled to the computing devices via the LAN/WAN/Internet 1410, wherein an Internet browser of the computing device requests and receives contact information.

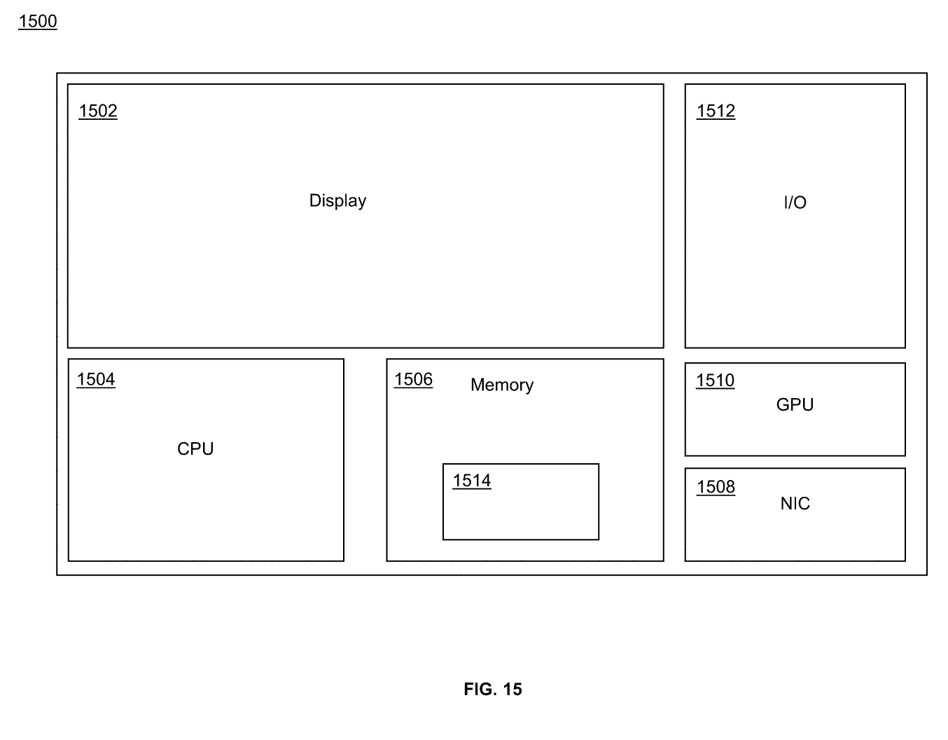

FIG. 15 illustrates an example device 1500 of the type that might be used to implement one or more of devices or servers as described in FIG. 14. As shown, device 1500 may include a display (e.g., a touch-screen display or a monitor) 1502, a central processing unit (CPU) 1504, one or more memory components 1506, a network interface component 1508 (e.g., a WiFi, Ethernet, or other such interface), a graphics programming unit (GPU) 1510, and one or more input/output interfaces 1512. CPU 1504 is configured to execute machine readable software code 1514 (which might correspond to any and all of the various software components described herein) and, via GPU 1510, render graphics on display 1502. GPU 1510 may include any of the various GPU components known in the art that are capable of interfacing with CPU 1504 (via an appropriate GPU application programming interface, or “API”) to render displayable components on to display 1502. In the context of a user interface employing a web browser, for example, such displayable components might include, without limitation, various text components, image components (e.g., JPG, PNG, etc.), video components (e.g., AVI, animated-GIFs, etc.), interactive user interface components (e.g., buttons, text entry regions), and widgets (such as date-picker and calendar widgets). Such displayable components, as is known in the art, may be produced by a web browser configured to parse and render web resources such as hypertext transfer markup language (HTML) files, cascading style sheet (CSS) files, Javascript code, and other such files used to render websites. Suitable browsers include, for example, Microsoft Internet Explorer, Microsoft Edge, Mozilla Firefox, Google Chrome, Apple Safari, Opera, or the like.

Unless specifically stated otherwise, as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a flash memory device, such as a compact flash card or USB flash drive.

Some exemplary embodiments described herein are described as software executed on at least one computer, though it is understood that embodiments can be configured in other ways and retain functionality. The embodiments can be implemented on known devices such as a server, a personal computer, a smart phone, a tablet device, a special purpose computer, a programmed microprocessor or microcontroller and peripheral integrated circuit element(s), and ASIC or other integrated circuit, a digital signal processor, a hard-wired electronic or logic circuit such as a discrete element circuit, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The terms determine, calculate and compute, and variations thereof, as used herein are used interchangeably and include any type of methodology, process, mathematical operation or technique.

The invention described and claimed herein is not to be limited in scope by the specific embodiments herein disclosed since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. All publications cited herein are incorporated by reference in their entirety.

What is claimed is:

1) A computer-implemented method for determining contacts names that may identify the same person comprising:
maintaining by one or more servers and one or more databases having contact records, wherein each contact record comprises one or more of a first name, middle name and a last name;
selecting a target contact record;
determining a similarity score between the target contact record and one or more of the other contact records in the one or more databases; and
displaying one or more of the other contact records based, at least in part, on the similarity score.

2) The computer-implemented method of claim 1, wherein determining a similarity score further comprises:
assigning a first similarity score if the target contact record exactly matches another contact record; and
assigning a second similarity score of less the first similarity score if the target contact record does not exactly match another contact record.

3) The computer-implemented method of claim 1, wherein determining a similarity score further comprises comprising:
comparing the first, middle and last names of the target contact record against the first, middle and last names of another contact record and determining a separate similarity score for each of the first, middle and last names; and
combining the similarity scores of the first, middle and last names into a final similarity score.

4) The computer-implemented method of claim 3, wherein combining the similarity scores further comprises: if any of the similarity scores for each of the first, middle or last names is less than a threshold, the final similarity score is a

5) The computer-implemented method of claim 4, wherein comparing the first, middle and last names further comprises:
determining if either the middle name of the other contact record is a single character that is the first character of the middle name of the target contact record or the middle name of the target contact record is a single character that is the first character of the middle name of the other contact record; and
generating a similarity score for the middle names which meets the threshold.

6) The computer-implemented method of claim 3, further comprising:
comparing the last name of the other record against the first name of the target record;
comparing the first name of the other record against the last name of the target record; and
determining a separate similarity score for each comparison.

7) The computer-implemented method of claim of 3 further comprising:
comparing the first name of the target record against one or more variations of the first name of the other contact record, wherein the variations have different spellings than the first name; and
determining a similarity score between the first name of the target record and one of the name variations of the other record.

8) A system comprising:
one or more databases storing data objects of contact records having one or more of a first name, middle name and a last name; and
a server system in communication with the one or more databases, the server system having one or more processors configured to cause:
selecting a target contact record;
determining a similarity score between the target contact record and one or more of the other contact records in the one or more databases; and
displaying one or more of the other contact records based, at least in part, on the similarity score.

9) The system of claim 8, wherein the one or more processors further configured to cause:
assigning a first similarity score if the target contact record exactly matches another contact record; and
assigning a second similarity score of less the first similarity score if the target contact record does not exactly match another contact record.

10) The system of claim 8, wherein the one or more processors further configured to cause:
comparing the first, middle and last names of the target contact record against the first, middle and last names of another contact record and determining a separate similarity score for each of the first, middle and last names; and
combining the similarity scores of the first, middle and last names into a final similarity score.

11) The system of claim 10, wherein the one or more processors further configured to cause: wherein combining the similarity scores further comprises: if any of the similarity scores for each of the first, middle or last names is less than a threshold, the final similarity score is 0.

12) The system of claim 11, wherein the one or more processors further configured to cause: wherein comparing the first, middle and last names further comprises:
determining if either the middle name of the other contact record is a single character that is the first character of the middle name of the target contact record or the middle name of the target contact record is a single character that is the first character of the middle name of the other contact record; and
generating a similarity score for the middle names which meets the threshold.

13) The system of claim 10, wherein the one or more processors further configured to cause:
comparing the last name of the other record against the first name of the target record;
comparing the first name of the other record against the last name of the target record; and
determining a separate similarity score for each comparison.

14) The system of claim 10, wherein the one or more processors further configured to cause:
comparing the first name of the target record against one or more variations of the first name of the other contact record, wherein the variations have different spellings than the first name; and
determining a similarity score between the first name of the target record and one of the name variations of the other record.

15) A computer program product comprising computer-readable program code capable of being executed by one or more processors when retrieved from a non-transitory computer-readable medium, the program code including instructions configurable to cause:
maintaining by one or more servers and one or more databases having contact records, wherein each contact record comprises one or more of a first name, middle name and a last name;
selecting a target contact record;
determining a similarity score between the target contact record and one or more of the other contact records in the one or more databases; and
displaying one or more of the other contact records based, at least in part, on the similarity score.

16) The computer programmable product of claim 15, wherein determining a similarity score further comprises:
assigning a first similarity score if the target contact record exactly matches another contact record; and
assigning a second similarity score of less the first similarity score if the target contact record does not exactly match another contact record.

17) The computer programmable product of claim 15, wherein determining a similarity score further comprises comprising:
comparing the first, middle and last names of the target contact record against the first, middle and last names of another contact record and determining a separate similarity score for each of the first, middle and last names; and
combining the similarity scores of the first, middle and last names into a final similarity score.

18) The computer programmable product of claim 17, wherein combining the similarity scores further comprises: if any of the similarity scores for each of the first, middle or last names is less than a threshold, the final similarity score is 0.

19) The computer programmable product of claim 18, wherein comparing the first, middle and last names further comprises:
determining if either the middle name of the other contact record is a single character that is the first character of the middle name of the target contact record or the middle name of the target contact record is a single character that is the first character of the middle name of the other contact record; and
generating a similarity score for the middle names which meets the threshold.

20) The computer programmable product of claim 17, further comprising:
comparing the last name of the other record against the first name of the target record;
comparing the first name of the other record against the last name of the target record; and
determining a separate similarity score for each comparison.
